(19) United States
(12) Patent Application Publication
(10) Pub. No.: US 2025/0264920 A1
(43) Pub. Date: Aug. 21, 2025

(54) SYSTEMS AND METHODS OF USING TRANSMISSION BLANKING

(71) Applicant: Meta Platforms Technologies, LLC, Menlo Park, CA (US)

(72) Inventors: Madhusudan Kinthada Venkata, South San Diego, CA (US); Mahesh Devdatta Telang, San Ramon, CA (US); Achaleshwar Sahai, San Jose, CA (US); Manjinder Sandhu, San Diego, CA (US); Shivank Nayak, Milpitas, CA (US)

(73) Assignee: Meta Platforms Technologies, LLC, Menlo Park, CA (US)

(21) Appl. No.: 19/052,021

(22) Filed: Feb. 12, 2025

Related U.S. Application Data
(60) Provisional application No. 63/554,185, filed on Feb. 16, 2024.

(51) Int. Cl. G06F 1/20; H04W 72/21; H04W 72/566

(52) U.S. Cl. CPC G06F 1/206; H04W 72/21; H04W 72/569

(57) ABSTRACT

Systems and method of using transmission blanking may include one or more processors of a communication device which receives data corresponding to a thermal level of a device. The communication device may receive one or more packets for transmission to a wireless communication node. The communication device may apply the thermal level to the one or more criterion, to selectively transmit, or forego transmission of, the one or more packets to the wireless communication node.

### CROSS-REFERENCE TO RELATED APPLICATIONS

This application claims the benefit of and priority to U.S. Provisional Application No. 63/554,185, filed Feb. 16, 2025, the contents of which are incorporated herein by reference in their entirety.

### FIELD OF DISCLOSURE

The present disclosure is generally related to wireless communication, including but not limited to, systems and methods of using transmission blanking.

### BACKGROUND

Augmented reality (AR), virtual reality (VR), and mixed reality (MR) are becoming more prevalent, which such technology being supported across a wider variety of platforms and device. Some AR/VR/MR devices may communicate with one or more other remote devices via a cellular connection.

### SUMMARY

In one aspect, this disclosure relates to a method, including receiving, by one or more processors of a device, data corresponding to a thermal level of the device. The method may include receiving, by the one or more processors, one or more packets for transmission to a wireless communication node. The method may include applying, by the one or more processors, the thermal level to one or more criterion, to selectively transmit, or forego transmission of, the one or more packets to the wireless communication node.

In some embodiments, the one or more criterion include one or more thermal criterion. The method may further include applying, by the one or more processors, the one or more packets to a selection criterion, responsive to the thermal level satisfying the thermal criterion for selectively forego transmission of at least one of the one or more packets. The method may further include transmitting, by the one or more processors, a first packet of the one or more packets. The method may further include forego transmission of, by the one or more processors, a second packet of the one or more packets. In some embodiments, the selection criterion corresponds to at least one of a channel corresponding to the one or more packets, a type of traffic included in the one or more packets, or a priority of the traffic included in the one or more packets. In some embodiments, the selection criterion corresponds to the channel corresponding to the one or more packets, where the first packet corresponds to a physical uplink control channel (PUCCH), and where the second packet corresponds to a physical uplink shared channel (PUSCH). In some embodiments, the selection criterion corresponds to the type of traffic included in the packet, where the first packet includes at least one of control traffic or latency-sensitive traffic, and where the second packet includes at least one of data traffic or background traffic. In some embodiments, the selection criterion corresponds to the priority of traffic included in the packet, where the first packet includes traffic with a higher priority level than traffic included in the second packet.

In some embodiments, the method further includes determining, by the one or more processors, a network condition corresponding to the wireless communication node. The method may further include selecting, by the one or more processors, a number of packets of the one or more packets in which to forego transmission, based on the network condition. In some embodiments, the one or more processors selects an increased number of packets in which to forego transmission based on the network conditions corresponding to first network performance metrics, and selects a decreased number of packets in which to forego transmission based on the network conditions corresponding to second network performance metrics reduced relative to the first network performance metrics.

In some embodiments, the one or more processors selectively forego transmission of the one or more packets by at least one of deactivating a power amplifier or blanking a packet provided to the power amplifier, for a transmission time interval in which the device is to transmit the one or more packets to the wireless communication node. In some embodiments, the one or more processors are of a modem of the device, and whereon the one or more processors receive the data corresponding to the thermal level from one or more application processors of the device.

In another aspect, this disclosure relates to a wireless communication device including a communication device having one or more processors configured to receive data corresponding to a thermal level of the wireless communication device. The one or more processors may be configured to receive one or more packets for transmission to a wireless communication node. The one or more processors may be configured to apply the thermal level to one or more criterion, to selectively transmit, or forego transmission of, the one or more packets to the wireless communication node.

In some embodiments, the one or more criterion include one or more thermal criterion, where the one or more processors are further configured to apply the one or more packets to a selection criterion, responsive to the thermal level satisfying the thermal criterion for selectively forego transmission of at least one of the one or more packets. The one or more processors may be configured to transmit a first packet of the one or more packets. The one or more processors may be configured to forego transmission of a second packet of the one or more packets. In some embodiments, the selection criterion corresponds to at least one of a channel corresponding to the one or more packets, a type of traffic included in the one or more packets, or a priority of the traffic included in the one or more packets. In some embodiments, the selection criterion corresponds to the channel corresponding to the one or more packets, where the first packet corresponds to a physical uplink control channel (PUCCH), and where the second packet corresponds to a physical uplink shared channel (PUSCH). In some embodiments, the selection criterion corresponds to the type of traffic included in the packet, where the first packet includes at least one of control traffic or latency-sensitive traffic, and where the second packet includes at least one of data traffic or background traffic. In some embodiments, the selection criterion corresponds to the priority of traffic included in the packet, and where the first packet includes traffic with a higher priority level than traffic included in the second packet.

In some embodiments, the one or more processors are further configured to determine a network condition corresponding to the wireless communication node, and select a number of packets of the one or more packets in which to forego transmission, based on the network condition. In some embodiments, the one or more processors selects an increased number of packets in which to forego transmission based on the network conditions corresponding to first network performance metrics, and selects a decreased number of packets in which to forego transmission based on the network conditions corresponding to second network performance metrics reduced relative to the first network performance metrics. In some embodiments, the one or more processors selectively forego transmission of the one or more packets by at least one of deactivating a power amplifier or blanking a packet provided to the power amplifier, for a transmission time interval in which the device is to transmit the one or more packets to the wireless communication node.

In yet another aspect, this disclosure relates to a non-transitory computer readable medium storing instructions that, when executed by one or more processors of a communication device implemented on a device, cause the one or more processors to receive data corresponding to a thermal level of the wireless communication device. The one or more processors may be further configured to receive one or more packets for transmission to a wireless communication node. The one or more processors may be further configured apply the thermal level to one or more criterion, to selectively transmit, or forego transmission of, the one or more packets to the wireless communication node.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is a block diagram of a system for using transmission blanking, according to an example implementation of the present disclosure.

FIG. 6 is a scheduling diagram showing example transmission blanking schemes according to network performance, according to an example implementation of the present disclosure.

FIG. 7 is a flowchart showing an example method of performing transmission blanking, according to an example implementation of the present disclosure.

FIG. 8 is a flowchart showing another example method of performing transmission blanking, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

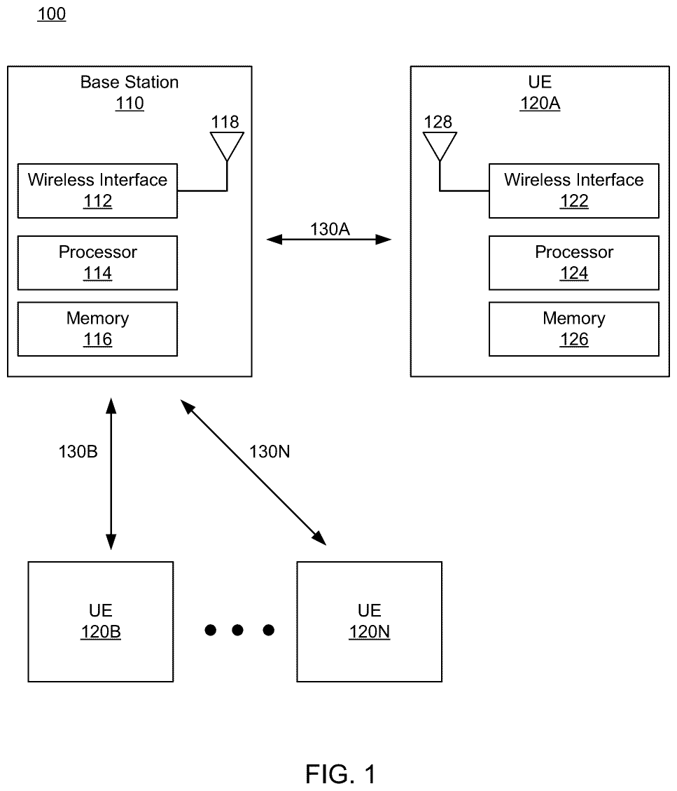

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

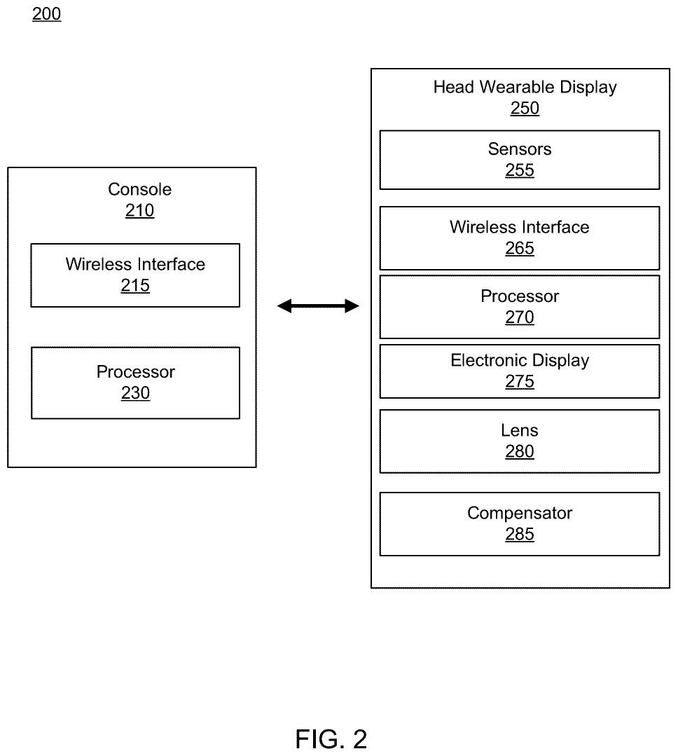

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

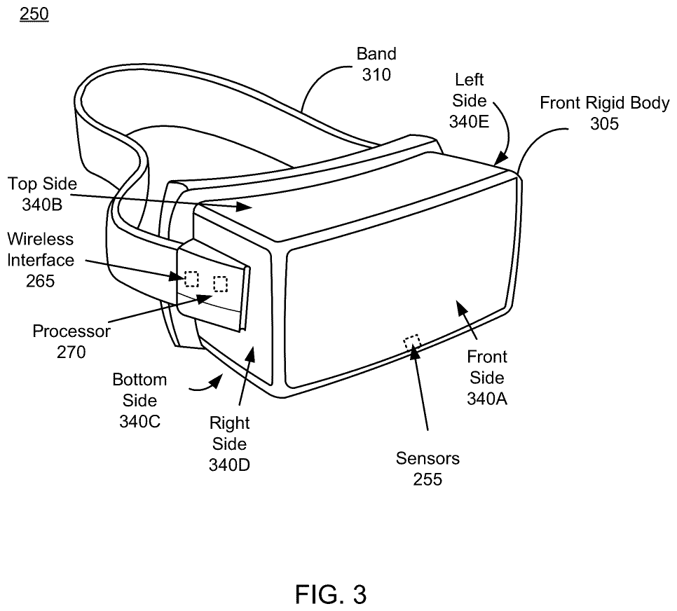

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

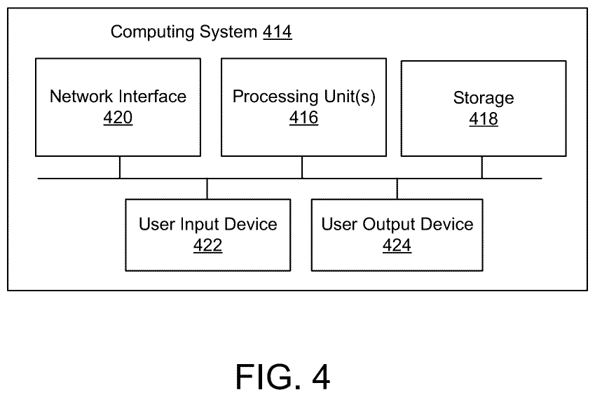

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHZ, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Referring generally to the FIGURES submitted herewith, this disclosure relates to systems and methods for throttling adjustment according to device performance. In particular, the systems and methods described herein provide for thermal mitigation for uplink communication, in low power and smaller form factor devices, such as wearable devices. Wireless devices with smaller form-factors may have higher thermal issues, which may be caused by the uplink/power amplifier. Some solutions may mitigate such thermal issues by applying maximum power based throttling (MTPL), which may impact all uplink channels including both control channels (e.g., physical uplink control channel [PUCCH]) and data channels (e.g., physical uplink shared channel [PUSCH]). Implementing MTPL may cause performance issues. For example, cell edge performance may have decreased performance due to uplink failures, and acknowledgements to downlink data and feedback (e.g., channel quality indicator [CQI] and/or rank indicator [RI]) may be dropped, resulting in downlink (DL) degradation.

According to the systems and methods described herein, the present solution may mitigate the thermal impact while not causing drastic degradation in cell edge performance. While described within the context of 4G radios, the systems and methods described herein may be applicable to various cellular network types and use cases. In various embodiments, a device may implement a transmission (TX) blanking feature which stops the uplink transmission(s) in a specific transmission time interval (TTI). The device may implement the TX blanking feature on TTIs according to various conditions. Such conditions may include, for instance, limiting application of the TX blanking feature on control channel data, or on TTIs carrying both data and control channel packets. Additionally or alternatively, the conditions may include, for example, limiting TX blanking to data channel TTIs, and may also include toggle blanking on a specific hybrid automatic repeat request (HARQ) identifiers carrying data channel data. In some embodiments, the device can apply the TX blanking feature in a telescoping manner, based on radio conditions.

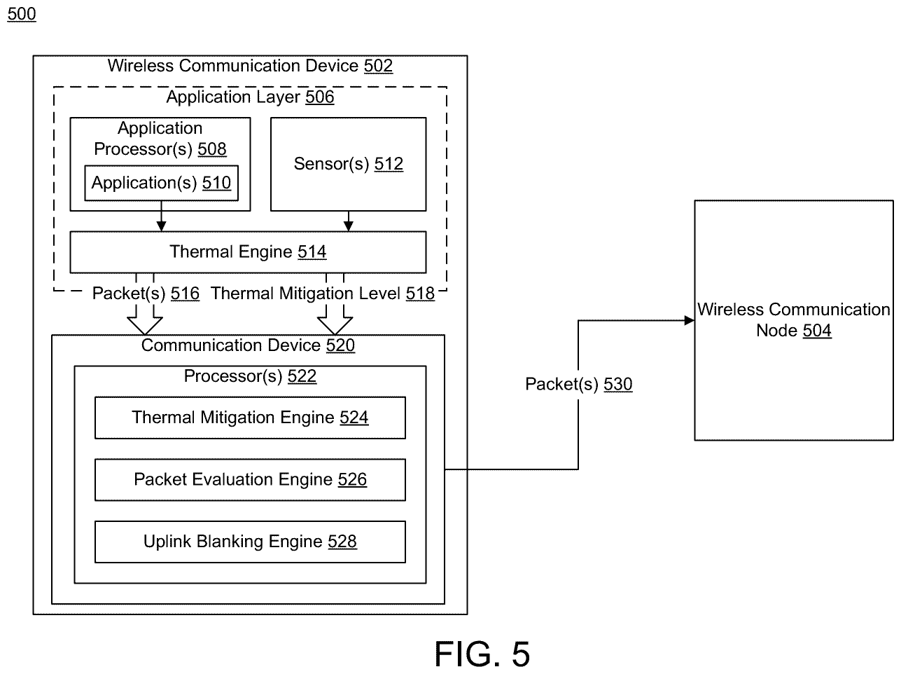

Referring now to FIG. 5, depicted is a block diagram of a system 500 for using transmission blanking, according to an example implementation of the present disclosure. The system 500 may include a wireless communication device 502 communicably coupled to a wireless communication node 504. The wireless communication device 502 (referred to generally as “the device 502”) may be similar to the user equipment 120, console 210, and/or head wearable display 250 described above with reference to FIG. 1-FIG. 4. The wireless communication node 504 may be similar to the base station 110 described above with reference to FIG. 1. The wireless communication device 502 may include a communication device 520 (also referred to as “modem 520”), which may be the same as or similar to the wireless interface 122, 215, 265 or network interface 420 described above with reference to FIG. 1-FIG. 4. As described in greater detail below, the communication device 520 may be configured to receive data corresponding to a thermal level of the wireless communication device 502, and receive one or more packets for transmission to the wireless communication node 504. The communication device 520 may be configured to apply the thermal level to one or more criterion, to selectively transmit and/or forego transmission of, various packet(s) to the wireless communication node 504.

According to the embodiments described herein, rather than applying a MPTL for uplink transmissions (e.g., across all transmission channels), the systems and methods described herein may selectively transmit/forego transmission of certain packets (e.g., by applying transmission blanking for certain transmission time intervals in which the packet(s) are to be transmitted). Such implementations may improve the performance of the device relative to MPTL application, particularly at cell edge, by avoiding uplink transmission power throttling that can cause dropped connections and result in latency. Additionally, by selectively transmitting certain packets (while foregoing transmission of other packets), the systems and methods described herein can ensure timely transmission of such packets that may include latency sensitive or control-related information, while simultaneously providing for opportunities for reduction in thermal levels of the device by foregoing transmission of the other packets (which thereby reduces usage of the power amplifier and heat produced thereby).

As shown in FIG. 5, the wireless communication device 502 may include an application layer 506 including one or more application processor(s) 508 executing one or more application(s) 510, and one or more sensor(s) 512. In executing the application(s) 510, the processor(s) 508 may be configured to generate various data/information/traffic for transmission via the communication device 520 to the wireless communication node 504. Such traffic may include, for example, data traffic (e.g., user-generated data, such as video, audio, voice, upload, or streaming content), foreground traffic (e.g., user-facing application data, such as active web browsing or real-time communication), background traffic (e.g., non-user-facing application data, such as software updates or synchronization processes), high-priority traffic (e.g., latency-sensitive data), low-priority traffic (e.g., non-urgent updates or batch processes), and so forth.

The sensor(s) 512 may be configured to determine, identify, sense, or otherwise detect various conditions of the wireless communication device 502. For example, the sensor(s) 512 may be or include temperature or thermal sensor(s) designed or configured to generate data corresponding to sensed thermal condition(s) of the device 502 (e.g., a skin temperature and/or one or more temperatures of portions/regions/areas/surfaces which are internal to the device 502).

The wireless communication device 502 may include one or more processing engines. The processing engines may be or include any component, element, or hardware designed or configured to perform, execute, or otherwise implement various functions of the device 502. In some embodiments, certain processing engine(s) may be implemented or executed at the application layer 506 (e.g., by the application processor(s) 508), and other processing engine(s) may be implemented or executed at other layers of the device 502, such as at the modem 520 (e.g., by one or more processor(s) 522 of the modem 520). For example, and in the implementation described with reference to FIG. 5, the device 502 may include a thermal engine 514 executing or implemented at the application layer 506, and a thermal mitigation engine 524, packet evaluation engine 526, and uplink blanking engine 528 executing or implemented at the modem 520 (e.g., by the processor(s) 522 of the modem 520). While these processing engines are shown and described, it is noted at that various additional and/or alternative processing engine(s) may be implemented on the device 502 (e.g., at the application layer, physical layer, and/or any intermediate layer therebetween). Additionally, in various embodiments, a processing engine may be divided into multiple processing engines, and/or two or more processing engines may be implemented as a single processing engine.

The wireless communication device 502 is shown to include various processors, including one or more application processor(s) 508 and one or more processor(s) 522 at the communication device 520. Such processor(s) may be similar to the processor(s) 124, 230, 270, or processing unit(s) 416 described above with reference to FIG. 1-FIG. 4. In various embodiments, the processor(s) 508, 522 may be components of a single processor (e.g., the processor(s) 508 may be one or more first cores of a processor, and the processor(s) 522 may be one or more second cores of a second processor). Additionally or alternatively, the processor(s) 508, 522 may be implemented as separate processors within the device 502 (e.g., dedicated processor(s) for executing the application 510, and dedicated processor(s) for the modem 520).

The thermal engine 514 may be designed or configured to receive various packet(s) from the application processor(s) 508, where such packet(s) include, incorporate, or otherwise provide the traffic described above (e.g., data traffic, foreground traffic, background traffic, etc.). The thermal engine 514 may be configured to receive sensor readings/data/information relating to the sensed conditions (e.g., thermal conditions) from the sensor(s) 512. The thermal engine 514 may be configured to communicate, transmit, signal, or otherwise message packet(s) 516 (e.g., corresponding to the traffic from the application(s) 510) and thermal mitigation level 518 to the communication device 520. In some embodiments, the thermal mitigation level 518 may be or include a temperature or thermal value (e.g., determined/identified/sensed by the sensor(s) 512). In some embodiments, the thermal mitigation level 518 may be or include a relative temperature or thermal value of the device 502 as compared to a threshold (e.g., 5° below the threshold, 10° above the threshold, etc.). In some embodiments, the thermal mitigation level 518 may be a binary indication of the temperature/thermal value of the device 502 relative to the threshold (e.g., whether the temperature of the device 502 is greater than (or greater than or equal to) or less than (or less than or equal to) the threshold). In some embodiments, the thermal mitigation level 518 may be a rate of change of the sensed thermal/temperature level (e.g., standalone rate of change, rate of change as compared to a threshold rate of change, and so forth).

The thermal mitigation engine 524 may be designed or configured to apply the thermal mitigation level 518 to one or more criterion, for implementing thermal mitigation of the device 502. In some embodiments, the thermal mitigation engine 524 may be configured to apply the thermal mitigation level 518 to various criterion, to determine a type of thermal mitigation to perform for the device 502. For example, where the thermal mitigation level 518 is a temperature or a rate of change of temperature of the device, the thermal mitigation engine 524 may be configured to apply the temperature/rate of change to a first criterion or threshold, to select a first thermal mitigation technique in which to perform thermal mitigation (e.g., transmission blanking). Where the temperature/rate of change satisfies a second criterion or threshold (e.g., a higher temperature or rate of change, as compared to the first criterion/threshold), the thermal mitigation engine 524 may be configured to select a second thermal mitigation technique in which to perform thermal mitigation (e.g., transmission power throttling). Where the temperature/rate of change satisfies a third criterion or threshold (e.g., a higher temperature or rate of change, as compared to the first and second criteria/thresholds), the thermal mitigation engine 524 may be configured to select a third thermal mitigation technique in which to perform thermal mitigation (e.g., temporary power down).

The packet evaluation engine 526 may be configured to inspect, analyze, or otherwise evaluate packets which are to be transmitted to the wireless communication node 504, to selectively transmit or forego transmission of such packet(s) where the thermal mitigation engine 524 selects the thermal mitigation technique as transmission blanking. Such packets may include the packets 516 received from the application layer 506, and/or additional/alternative packets. For example, the packets may include or comprise data traffic (such as the traffic generated and received from the application layer 506 and included in the packets 516), control traffic (e.g., signaling traffic, such as acknowledgements (ACKs), negative acknowledgements (NACKs), channel quality indicators (CQIs), rank indicators (RIs), scheduling requests (SRs), session management messages, handover messages, and so forth), and/or combinations of data/control traffic. Such packets may be transmitted (or scheduled for transmission) on various channels, such as a physical uplink control channel (PUCCH), physical uplink shared channel (PUSCH), or on a channel which combines both PUCCH and PUSCH data/information/packets. While the data traffic may be generated at the application layer 506, the control traffic may in some implementations be generated at other layers of the device, such as at the medium access control (MAC) layer, radio link control (RLC) layer, and/or physical layer by the modem 520, depending on the type of control traffic and its use. In this regard, the packet evaluation engine 526 may be configured to evaluate outbound (or uplink) packets, which are to be transmitted by the communication device 520 to the wireless communication node 504, which may include packets 516 and additional packets from other layers of the device 502 (including packets generated by the communication device 520).

In some embodiments, the packet evaluation engine 526 may be configured to apply the packets to one or more transmission blanking criterion, to determine which packets are to be transmitted. In some embodiments, the packet evaluation engine 526 may analyze the header or associated metadata of each packet, to identify the packet's contents, such as whether the packet includes PUCCH information, PUSCH information, a combination of PUSCH/PUCCH information, and/or other information. The packet evaluation engine 526 may be configured to selectively mark, flag, indicate, or otherwise identify packets for transmission (or to forego transmission) based on the contents, according to the contents of the packet as applied to the transmission blanking criterion. For example, where the packet evaluation engine 526 determines to transmit a particular packet, the packet evaluation engine 526 may be configured to mark or otherwise indicate that the packet is for transmission and move the packet to a transmission queue. Where the packet evaluation engine 526 determines to forego transmission of a particular packet, the packet evaluation engine 526 may be configured to mark or otherwise indicate the packet accordingly, and move the packet to a buffer for later transmission or for dropping (e.g., if the packet expires or becomes stale).

In some embodiments, the transmission blanking criteria may include a criterion that limits or foregoes transmission blanking on packets carrying PUCCH information. The packet evaluation engine 526 may inspect the packet headers or signaling metadata to determine whether the packet contains PUCCH information. As noted above, PUCCH packets may include include control-related information, such as acknowledgments (ACKs/NACKs), scheduling requests, and/or CQIs. Upon identifying PUCCH information in a packet, the packet evaluation engine 526 may mark the packet for transmission. In this regard, the packet evaluation engine 526 may be configured to facilitate transmission of PUCCH information by foregoing transmission blanking of packets which include such information.

In some embodiments, the transmission blanking criteria may include a criterion that limits or foregoes transmission blanking on packets that carry both control and data information (e.g., packets containing both PUCCH and PUSCH information). The packet evaluation engine 526 may be configured to evaluate the payload, headers, or associated signaling of a packet, to determine whether the packet includes a combination of PUCCH and PUSCH information. For example, such packets may contain uplink control signaling (e.g., acknowledgments, CQIs) alongside uplink data (e.g., user data or application traffic). Upon identifying such packets, the packet evaluation engine 526 may mark the corresponding packet for transmission. In this regard, the packet evaluation engine 526 may be configured to facilitate the transmission of packets carrying both control and data information, by foregoing transmission blanking of such packets.

In some embodiments, the transmission blanking criteria may include a criterion that toggles transmission blanking for specific hybrid automatic repeat request (HARQ) identifiers (IDs) carrying PUSCH data. Generally speaking, HARQ may involve retransmission of certain packets to provide for reliability of such packets when errors are detected. The packet evaluation engine 526 may compare a HARQ ID of a packet to a predefined set of HARQ IDs associated with blanking conditions. If the HARQ ID satisfies the blanking criterion, the packet evaluation engine 526 may mark the packet to forego transmission and move it to the buffer for possible retransmission at a later time.

In some embodiments, the transmission blanking criteria may include a criterion that applies transmission blanking on packets designated for the PUSCH channel (e.g., packets containing data traffic). The packet evaluation engine 526 may analyze channel indicators or signaling metadata to determine whether a packet is associated with the PUSCH channel. For example, such packets may include non-latency-sensitive data traffic, such as background uploads or other low-priority data. If the packet evaluation engine 526 determines that the packet satisfies the blanking criterion, the packet evaluation engine 526 may mark the packet to forego transmission and move it to a buffer. Packets placed in the buffer may later be transmitted, unless they expire, in which case they are dropped.

In some embodiments, the packet evaluation engine 526 may be configured to evaluate packets for selectively performing transmission blanking based on the latency sensitivity of the traffic included in the packets. For example, where the packets include PUSCH information or traffic, the packet evaluation engine 526 may analyze metadata, traffic indicators, or associated signaling to determine whether or not the traffic is latency-sensitive. For instance, packets carrying less latency-sensitive traffic, such as background data transfers, software updates, or batch uploads, may be marked for transmission blanking and moved to a buffer for later transmission or dropped upon expiration. Packets containing latency-sensitive traffic, such as real-time voice, video, or interactive gaming data, may be marked for immediate transmission.

In some embodiments, the packet evaluation engine 526 may be configured to evaluate packets for selectively performing transmission blanking, based on the priority of the packets. For example, the packet evaluation engine 526 may evaluate priority levels indicated in the packet headers or assigned by the application layer 506 (or other layer(s) of the device 502). Packets identified as lower-priority traffic, such as routine synchronization tasks or non-critical telemetry data, may be marked for transmission blanking, whereas packets carrying higher-priority traffic, such as emergency alerts, critical system updates, or essential communication signals, may be marked for transmission and moved to the transmission queue.

In some embodiments, the packet evaluation engine 526 may be configured to evaluate packets for selectively performing transmission blanking based on the type of traffic included in the packets. For example, the packet evaluation engine 526 may identify packets which include foreground traffic (e.g., user-facing application traffic such as active browsing, streaming, or video calls) as compared to packets which include background traffic (e.g., background uploads, app synchronization, or system updates). Packets carrying background traffic may be marked for transmission blanking, as foregoing transmission of such packets may not have a significant impact on user experience. Packets containing foreground traffic may be marked for transmission, to provide better user experience and application performance.

In some embodiments, the packet evaluation engine 526 may be configured to evaluate packets for selectively performing transmission blanking based on network conditions. For example, the packet evaluation engine 526 may assess network performance metrics, such as signal-to-noise ratio (SNR), CQI, throughput levels, or any other network performance metrics, to determine the conditions of the wireless communication link to the wireless communication node 504. In strong network conditions (e.g., high SNR or CQI), the packet evaluation engine 526 may blank a greater number of packets, as such strong network performance may allow for sufficient retransmission opportunities without significantly degrading the communication quality. In poor network conditions (e.g., low SNR or CQI), the packet evaluation engine 526 may blank fewer packets to avoid excessive retransmissions or dropped connections, which could further degrade performance.

The uplink blanking engine 528 may be designed or configured to selectively transmit or forego transmission of packet(s) (e.g., transmit as packets 530) to the wireless communication node 504, according to the packets evaluated by the packet evaluation engine 526. In some embodiments, the uplink blanking engine 528 may perform transmission blanking by blanking a transmission time interval (TTI) in which one or more packets are scheduled for transmission. The blanking of a TTI may mitigate power consumption and provide thermal dissipation, by reducing or eliminating the activity of the power amplifier associated with the communication device 502 during the blanked TTI.

In some embodiments, the uplink blanking engine 528 may blank a TTI by zeroing out the packet(s) scheduled for transmission in the blanked TTI. For instance, the uplink blanking engine 528 may be configured to replace the data payload of the packet(s) with zeroes or a null signal, thereby providing a packet which in which the power amplifier does not receive any data for amplification during the blanked TTI. In such implementations, the uplink blanking engine 528 facilitates the power amplifier to remain active but idle, thereby avoiding signal amplification while preserving synchronization with subsequent TTIs. Such embodiments may be advantageous in scenarios where the interval between consecutive transmissions is short, and allows the power amplifier to transition to the next scheduled transmission without the latency or power overhead associated with deactivation and reactivation of the power amplifier.

In some embodiments, the uplink blanking engine 528 may blank a TTI by deactivating or terminating the link to the power amplifier, thereby placing the power amplifier in a low-power or sleep state during the blanked interval. For example, the uplink blanking engine 528 may control a signal path switch or related circuitry, to disconnect a transmission signal from the power amplifier during the blanked TTI. Such embodiments may be implemented in scenarios where the interval between transmissions spans multiple TTIs, as the extended idle period may provide sufficient time for the power amplifier to transition back to an active state in preparation for subsequent transmissions. In such embodiments, the uplink blanking engine 528 may be configured to control the signal path switch/related circuitry to coordinate the timing of power amplifier deactivation and reactivation, to activate the amplifier in synchronization with the next scheduled transmission.

In some embodiments, the uplink blanking engine 528 may be configured to dynamically switch between blanking methods (e.g., zeroing out the packet(s) or deactivating the power amplifier) based on scheduling information or timing data received from the packet evaluation engine 526 and/or other scheduling components within the communication device 520. For example, the uplink blanking engine 528 may analyze the number of TTIs between the current TTI and the next scheduled TTI. Where the interval is short, the uplink blanking engine 528 may be configured to select the zeroing-out blanking scheme to maintain the power amplifier in an active state. Where the interval is longer, the uplink blanking engine 528 may be configured to select the link deactivation scheme to conserve energy and further reduce thermal generation.

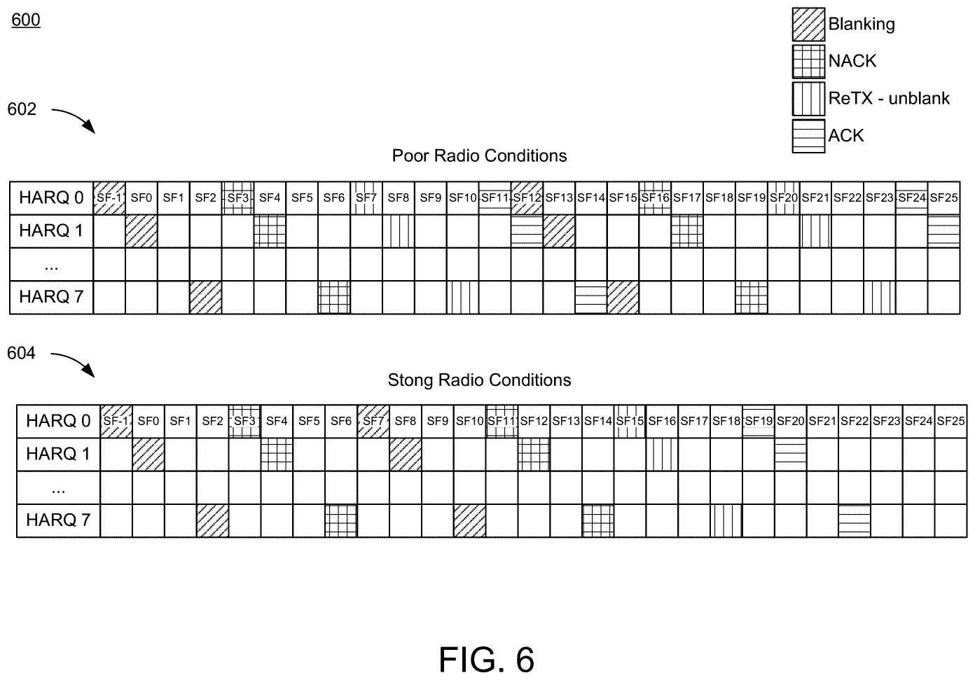

Referring now to FIG. 6, depicted is a scheduling diagram 600 showing example transmission blanking schemes 602, 604 according to network performance, according to an example implementation of the present disclosure. As shown in FIG. 6, for each transmission blanking scheme, in the left-most column, the rows are labeled with HARQ identifiers (e.g., HARQ 0, HARQ 1, . . . . HARQ 7), which represent the individual HARQ processes used to manage retransmissions. The top-most row is labeled with subframe indices (e.g., SF-1, SF0, SF1, . . . . SF25), which correspond to sequential subframes in the transmission timeline. Each subframe SF may be representative of a respective TTI (which may be 1 millisecond, though other TTIs may be used). Each cell is representative of a packet which is to be transmitted, and corresponding to a respective HARQ identifier, in the corresponding subframe.

As shown in the differences between the transmission blanking schemes 602, 604, the packet evaluation engine 526 and uplink blanking engine 528 may be configured to implement different transmission blanking schemes 602, 604 according to network performance. For example, in poor (or weak) radio conditions (represented by corresponding negative network performance metrics, such as low SNR, low CQI, etc.), the packet evaluation engine 526 and uplink blanking engine 528 may be configured to implement a transmission blanking scheme similar to the first transmission blanking scheme 602. In strong radio conditions (represented by corresponding positive or strong network performance metrics, such as high SNR, high CQI, etc.), the packet evaluation engine 526 and uplink blanking engine 528 may be configured to implement a transmission blanking scheme similar to the second transmission blanking scheme 604.

In the first transmission blanking scheme 602, the packet evaluation engine 526 may be configured to selectively mark packets for blanking, for certain HARQ IDs (e.g., HARQ 0, HARQ 1, and HARQ 7). For example, the packet evaluation engine 526 may be configured to selectively mark the packets for such HARQ IDs which are to be transmitted in SF-1, SF0, and SF2, respectively, for blanking. Because these packets are blanked, in the corresponding subsequent SFs (e.g., SF3, SF4, and SF6), the communication device 520 may correspondingly receive a NACK for each of the packets. Because the first transmission blanking scheme 602 may be implemented in poor radio conditions, the packet evaluation engine 526 may be configured to unblank the corresponding retransmission (e.g., to be sent in SF7, SF8, and SF10, respectively), to account for potential subsequent NACKs and retransmissions as appropriate.

In contrast with the first transmission blanking scheme 602, the second transmission blanking scheme 604 (which may be implemented in strong radio transmissions), the packet evaluation engine 626 may be configured to blank the retransmissions to be sent in the corresponding subsequent frames (e.g., in SF7, SF8, and SF10, respectively), understanding that their later retransmissions when unblanked (e.g., at SF15, SF16, and SF18, respectively) are likely to receive corresponding ACKs and thus may not need to be retransmitted, given the strong network performance.

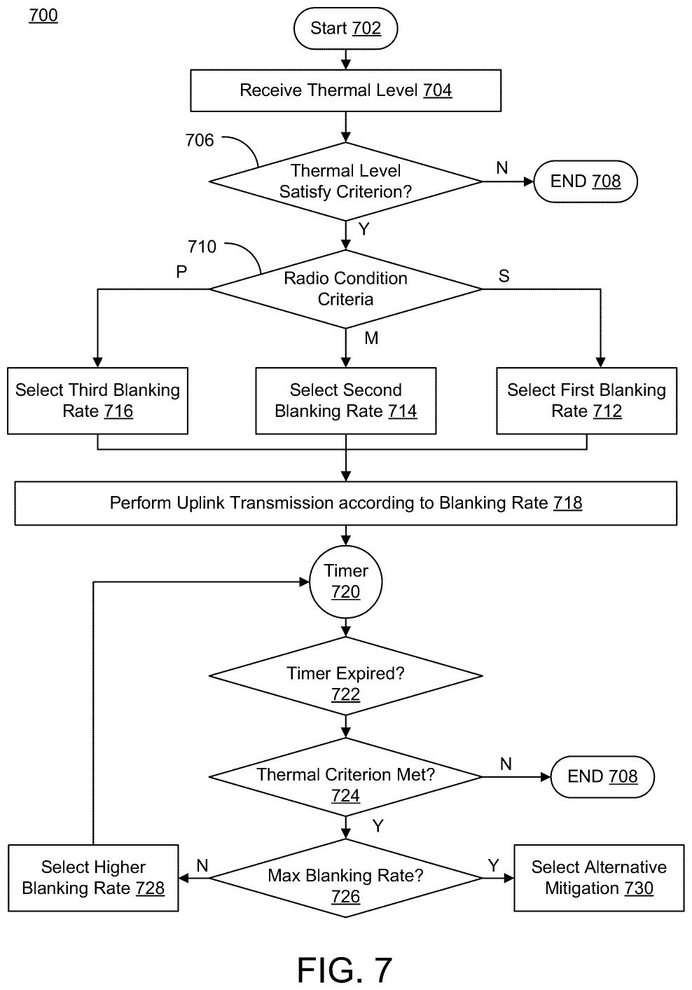

Referring now to FIG. 7, depicted is a flowchart showing an example method 700 of performing transmission blanking, according to an example implementation of the present disclosure. The method 700 may be performed by the devices, elements, hardware, or components described above with reference to FIG. 1-FIG. 6, such as the wireless communication device 502 and/or communication device 520 thereof.

The method 700 may begin at step 702. At step 704, the communication device 520 may receive data corresponding to the thermal level of the device 502. In some embodiments, the communication device may receive the data corresponding to the thermal level from the thermal engine 514 and/or from the sensor(s) 512. The data corresponding to the thermal level may be or include an absolute temperature or thermal level of the device (e.g., skin temperature and/or internal temperature), a relative temperature (e.g., the temperature or thermal level as compared to a threshold), and/or a rate of change of the temperature (e.g., over a time period). At step 706, the communication device 520 may determine whether the thermal level (e.g., received at step 704) satisfies a criterion. For example, the communication device 520 (e.g., the thermal mitigation engine 524) may determine whether the thermal level meets or exceeds one or more thermal-related thresholds (e.g., a temperature/rate of change, etc. for triggering thermal mitigation). Where, at step 706, the communication device 520 determines that the thermal level does not satisfy the thermal mitigation criterion (e.g., the thermal level/temperature/rate of is less than, or less than or equal to, the thermal-related threshold), the method may end at step 708.

Where, at step 706, the communication device 520 determines that the thermal level satisfies the thermal mitigation criterion, the method may proceed to step 710. At step 710, the communication device 520 (e.g., the packet evaluation engine 526) may determine a radio condition and apply the radio condition to a criterion. The communication device 520 may determine the radio condition based on network performance metrics received or otherwise determined by the communication device 520 (e.g., signal-to-noise ratio, channel quality indicator, a count of NACKs, data throughput, and so forth). The communication device 520 may apply the radio condition to one or more criterion, to determine whether the radio conditions are strong, moderate, or poor. For example, the communication device 520 may determine that the radio conditions are strong where the SNR is above a first threshold, the communication device 520 may determine that the radio conditions are moderate where the SNR is below the first threshold and above a second threshold, and the communication device 520 may determine that the radio conditions are poor where the SNR is below the second threshold. Additional examples for CQI, count of NACKs, data throughput, and other network performance metrics may be used for determining whether the radio conditions are strong, moderate, or poor.

Where the radio conditions are strong, the packet evaluation engine 526 may select a first blanking (e.g., transmission blanking) rate. The first blanking rate may be relatively high, as the strong network conditions may indicate that subsequent transmissions of packets in later TTIs are likely to be received and acknowledged. Where the radio conditions are moderate, the packet evaluation engine 526 may select a second blanking rate (less than the first blanking rate). The packet evaluation engine 526 may select the second blanking rate (e.g., a reduced blanking rate), as subsequent transmissions of packets in later TTIs may or may not be received or acknowledged. Where the radio conditions are poor, the packet evaluation engine 526 may select a third blanking rate (less than the first and second blanking rates). The packet evaluation engine 526 may select the third blanking rate (e.g., a relatively low blanking rate), as subsequent transmissions of packets in later TTIs are likely not be received or acknowledged, and thus may need to be retransmitted (and therefore cause latency issues). In this regard, the packet evaluation engine 526 may be configured to execute or implement a telescoping blanking rate which is tied to various metrics (such as radio condition). While described in the context of radio condition, it should be understood that similar criterion could be applied to other metrics, such as thermal level (e.g., using the first blanking rate for high temperatures to rapidly reduce thermal levels of the device, using the second blanking rate for moderately high temperatures, and using the third blanking rate for slightly elevated temperatures).

At step 718, the communication device 520 (e.g., the uplink blanking engine 528) may perform uplink transmissions according to the blanking rate (e.g., selected at steps 712-716). The communication device 520 may selectively transmit, for forego transmission of, certain packets, according to the blanking rate. In some embodiments, the communication device 520 may apply one or more blanking criterion to determine which packet(s) to blank, according to contents of the packets. For example, the communication device 520 may apply one or more blanking criterion, to selectively blank packet(s) which include PUSCH traffic, packet(s) which include background traffic, packet(s) which include less latency-sensitive traffic, and so forth. The communication device 520 may perform transmission blanking on packet(s), for TTIs in which the packet(s) are to be sent to the wireless communication node, to forego transmission of those packets determined to selectively blank. The communication device 520 may move the corresponding packet(s) to a buffer, for later transmission and/or discarding responsive to their expiration. The communication device 520 may transmit packet(s) which are determined not to be blanked (e.g., latency-sensitive packets, packets including PUCCH traffic, packets including foreground traffic, packets including both PUCCH/PUSCH traffic, and so forth).

At step 720, the communication device 520 may initiate a timer. The timer may measure or determine a duration in which the communication device 520 is to perform uplink transmission according to the blanking rate at step 718. For example, the timer may measure or determine a duration which corresponds to a number of TTIs (e.g., 20 ms, 50 ms, etc.). Upon expiration of the timer (e.g., at step 722), the communication device 520 may determine whether the thermal criterion is met (e.g., similar to the determination made at step 706). Where the thermal criterion is not met (e.g., the thermal level is less than, or less than or equal to, the thermal criterion), the method 700 may end at step 708. Where the thermal criterion is met, the method 700 may proceed to step 726.

At step 726, the communication device 520 may determine whether the maximum blanking rate has been selected. For example, the maximum blanking rate may be the first blanking rate selected at step 712. Where the maximum blanking rate has not been selected, the method 700 may proceed to step 728, where the communication device 520 selects a higher blanking rate and proceeds back to step 720. For example, assuming the radio conditions are moderate (or poor) and the communication device 520 initially attempts thermal mitigation at the second (or third) blanking rate at steps 714, 716, and the thermal criterion is still met after expiry of the timer, the communication device 520 may select a higher blanking rate (e.g., the first or second blanking rate) for a subsequent iteration of the method 700 until the maximum blanking rate is selected or until the thermal criterion is no longer met. In this regard, the communication device 520 may select a higher blanking rate in moderate or poor radio conditions, where such a higher blanking rate may result in increased latency or potential dropped connections, to reduce the thermal level of the device in the event that the lower blanking rate is not achieving the desired thermal reduction impact.

If, at step 726, the communication device 520 determines that the maximum blanking rate has been selected, the communication device 520 may select alternative thermal mitigation techniques, such as maximum transmission power throttling and/or temporary power down.

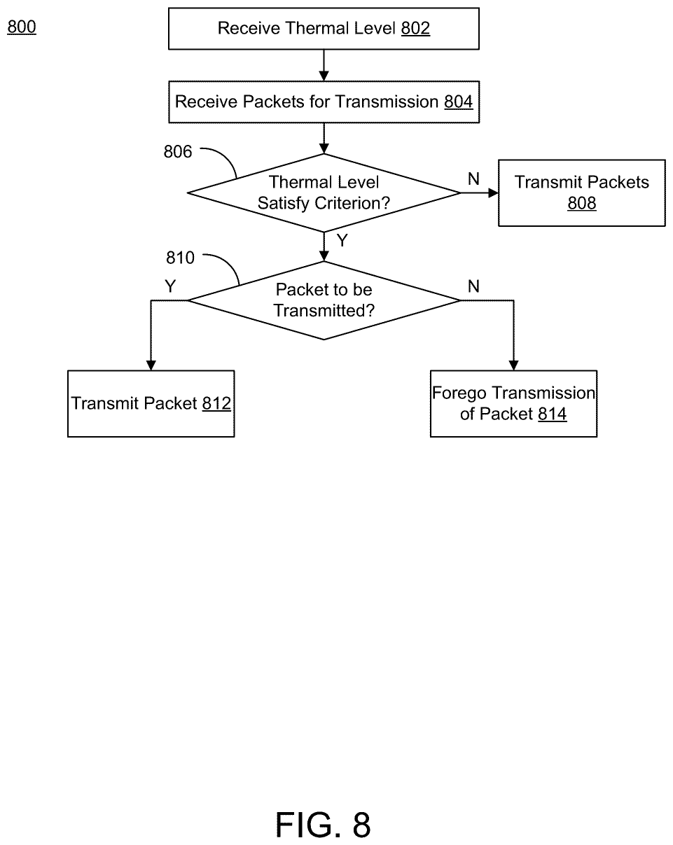

Referring now to FIG. 8, depicted is a flowchart showing an example method 800 of performing transmission blanking, according to another example implementation of the present disclosure. The method 800 may be performed by the devices, elements, hardware, or components described above with reference to FIG. 1-FIG. 6, such as the wireless communication device 502 and/or communication device/modem 520 thereof. As a brief overview, at step 802, a communication device may receive a thermal level. At step 804, the communication device may receive packets for transmission. At step 806, the communication device may determine whether the thermal level satisfies a criterion. At step 808, the communication device may transmit packets. At step 810, the communication device may determine whether a respective packet is to be transmitted. At step 812, the communication device may transmit the packet. At step 814, the communication device may forego transmission of the packet.

At step 802, a communication device may receive a thermal level. In some embodiments, the communication device/modem (or processor(s) thereof) may receive data corresponding to a thermal level of the device (e.g., the device which includes the communication device/modem). The communication device may receive the thermal level of the device, from one or more processors of the device. For example, the communication device may receive the thermal level from an application processor of the device (e.g., which executes the thermal engine 514), based on sensor data from sensor(s) of the device. The communication device may receive the thermal level at various intervals, such as periodically, on-demand, and so forth. The thermal level may be or include a temperature (skin temperature or internal temperature), a rate of change of the temperature, a relative temperature (as compared to a threshold), and so forth.

At step 804, the communication device may receive packets for transmission. In some embodiments, the communication device may receive packets for transmission from the application processor(s) (e.g., at the application layer) and/or packets from other layers of the device (such as the MAC layer, RLC layer, physical layer, and so forth). Such packets may include various types of traffic, such as data traffic, control traffic, foreground/background traffic, high priority/low priority traffic, and so forth. Such packets may include information which indicates the type of traffic (e.g., metadata, payload, headers, and so forth).

At step 806, the communication device may determine whether the thermal level satisfies a criterion. In some embodiments, the communication device may apply the thermal level received at step 802 to the criterion. The criterion may be or include a thermal criterion. The communication device may apply the thermal level to the criterion, prior to transmission of the packets received at step 804. The communication device may apply the thermal level to the criterion, to selectively transmit, or forego transmission of, the packets received at step 804 to the wireless communication node. Where the criterion is not satisfied (e.g., the thermal level is less than, or less than or equal to, a threshold thermal level), the method 800 may proceed to step 808, where the communication device transmits each of the packets (e.g., received at step 804) during their respective TTIs. Where the criterion is satisfied (e.g., the thermal level is greater than, or greater than or equal to, the threshold thermal level), the method 800 may proceed to step 810.

At step 810, the communication device may determine whether a respective packet is to be transmitted. In some embodiments, the communication device may apply the plurality of packets to a selection criterion, to selectively forego transmission of at least some of the packet(s) received at step 804. For example, the communication device may apply each respective packet to the selection criterion, to selectively forego transmission of the respective packet. In some embodiments, the selection criterion may correspond to a channel corresponding to the packet (e.g., PUSCH, PUCCH, etc.), a type of traffic included in the packet (e.g., data traffic, control traffic, foreground traffic, background traffic, latency-sensitive traffic, less latency-sensitive traffic, etc.), or a priority of the traffic included in the one or more packets (e.g., high priority level traffic, low priority level traffic, etc.).

In some embodiments, the communication device may determine a network condition corresponding to the wireless communication node. For example, the communication device may determine network performance metrics relating to a communication link between the communication device and the wireless communication node, such as a signal-to-noise ratio, a channel quality indicator (CQI), a data throughput, and so forth. The communication device may select a number of packets in which to forego transmission (e.g., a blanking rate), based on the network condition. For example, the communication device may select an increased number of packets in which to forego transmission for strong network conditions, and may select a reduced number of packets in which to forego transmission for weak or moderate network conditions.

At step 812, the communication device may transmit the packet. In some embodiments, responsive to determining to transmit a packet (e.g., to not forego transmission of a packet, based on the selection criterion not being satisfied), the communication device may transmit the packet to the wireless communication node. For example, the communication device may move the packet to a transmission queue for transmission to the wireless communication node during a corresponding TTI. The communication device may transmit the packet at step 812 during the TTI in which the packet is scheduled for transmission.

At step 814, the communication device may forego transmission of the packet. In some embodiments, responsive to determining to forego transmission of a packet (e.g., based on the selection criterion being satisfied), the communication device may forego transmission of the packet to the wireless communication node (e.g., during the TTI in which the packet was scheduled for transmission). The communication device may forego transmission of the packet, by moving the packet to a buffer for subsequent retransmission in a later TTI and/or for discarding responsive to expiry of the packet.

In some embodiments, to forego transmission of the packet, the communication device may deactivate a power amplifier for at least the TTI in which the device was to transmit the packet to the wireless communication node. In some embodiments, to forego transmission of the packet, the communication device may blank the packet (e.g., by zeroing or nulling the packet) provided to the power amplifier, for the TTI. In each of these implementations, the power amplifier may not amplify a signal (e.g., either due to the power amplifier being deactivated or by blanking the signal which is to be amplified), thereby reducing power consumption and corresponding thermal output from the power amplifier.

In some embodiments, the method may cycle between steps 804 and 814 for each packet, until the thermal level no longer satisfies the criterion. In this regard, the method may repeat for each of the packets, until the thermal condition of the device has improved (or the device determines to select an alternative thermal mitigation technique, such as transmission power throttling and/or device power-down).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by one or more processors of a device, data corresponding to a thermal level of the device;
receiving, by the one or more processors, one or more packets for transmission to a wireless communication node; and
applying, by the one or more processors, the thermal level to one or more criterion, to selectively transmit, or forego transmission of, the one or more packets to the wireless communication node.

2. The method of claim 1, wherein the one or more criterion comprise one or more thermal criterion, the method further comprising:
applying, by the one or more processors, the one or more packets to a selection criterion, responsive to the thermal level satisfying the thermal criterion for selectively forego transmission of at least one of the one or more packets;
transmitting, by the one or more processors, a first packet of the one or more packets; and
forego transmission of, by the one or more processors, a second packet of the one or more packets.

3. The method of claim 2, wherein the selection criterion corresponds to at least one of a channel corresponding to the one or more packets, a type of traffic included in the one or more packets, or a priority of the traffic included in the one or more packets.

4. The method of claim 3, wherein the selection criterion corresponds to the channel corresponding to the one or more packets, wherein the first packet corresponds to a physical uplink control channel (PUCCH), and wherein the second packet corresponds to a physical uplink shared channel (PUSCH).

5. The method of claim 3, wherein the selection criterion corresponds to the type of traffic included in the packet, wherein the first packet comprises at least one of control traffic or latency-sensitive traffic, and wherein the second packet comprises at least one of data traffic or background traffic.

6. The method of claim 3, wherein the selection criterion corresponds to the priority of traffic included in the packet, and wherein the first packet comprises traffic with a higher priority level than traffic included in the second packet.

7. The method of claim 1, further comprising:
determining, by the one or more processors, a network condition corresponding to the wireless communication node; and
selecting, by the one or more processors, a number of packets of the one or more packets in which to forego transmission, based on the network condition.

8. The method of claim 7, wherein the one or more processors selects an increased number of packets in which to forego transmission based on the network condition corresponding to first network performance metrics, and selects a decreased number of packets in which to forego transmission based on the network condition corresponding to second network performance metrics reduced relative to the first network performance metrics.

9. The method of claim 1, wherein the one or more processors selectively forego transmission of the one or more packets by at least one of deactivating a power amplifier or blanking a packet provided to the power amplifier, for a transmission time interval in which the device is to transmit the one or more packets to the wireless communication node.

10. The method of claim 1, wherein the one or more processors are of a modem of the device, and whereon the one or more processors receive the data corresponding to the thermal level from one or more application processors of the device.

11. A wireless communication device, comprising:
a communication device comprising one or more processors configured to:
receive data corresponding to a thermal level of the wireless communication device;
receive one or more packets for transmission to a wireless communication node; and
apply the thermal level to one or more criterion, to selectively transmit, or forego transmission of, the one or more packets to the wireless communication node.

12. The wireless communication device of claim 11, wherein the one or more criterion comprise one or more thermal criterion, wherein the one or more processors are further configured to:
apply the one or more packets to a selection criterion, responsive to the thermal level satisfying the thermal criterion for selectively forego transmission of at least one of the one or more packets;
transmit a first packet of the one or more packets; and
forego transmission of a second packet of the one or more packets.

13. The wireless communication device of claim 12, wherein the selection criterion corresponds to at least one of a channel corresponding to the one or more packets, a type of traffic included in the one or more packets, or a priority of the traffic included in the one or more packets.

14. The wireless communication device of claim 13, wherein the selection criterion corresponds to the channel corresponding to the one or more packets, wherein the first packet corresponds to a physical uplink control channel (PUCCH), and wherein the second packet corresponds to a physical uplink shared channel (PUSCH).

15. The wireless communication device of claim 13, wherein the selection criterion corresponds to the type of traffic included in the packet, wherein the first packet comprises at least one of control traffic or latency-sensitive traffic, and wherein the second packet comprises at least one of data traffic or background traffic.

16. The wireless communication device of claim 13, wherein the selection criterion corresponds to the priority of traffic included in the packet, and wherein the first packet comprises traffic with a higher priority level than traffic included in the second packet.

17. The wireless communication device of claim 11, wherein the one or more processors are further configured to:
determine a network condition corresponding to the wireless communication node; and
select a number of packets of the one or more packets in which to forego transmission, based on the network condition.

18. The wireless communication device of claim 17, wherein the one or more processors selects an increased number of packets in which to forego transmission based on the network condition corresponding to first network performance metrics, and selects a decreased number of packets in which to forego transmission based on the network condition corresponding to second network performance metrics reduced relative to the first network performance metrics.

19. The wireless communication device of claim 11, wherein the one or more processors selectively forego transmission of the one or more packets by at least one of deactivating a power amplifier or blanking a packet provided to the power amplifier, for a transmission time interval in which the device is to transmit the one or more packets to the wireless communication node.

20. A non-transitory computer readable medium storing instructions that, when executed by one or more processors of a communication device implemented on a device, cause the one or more processors to:
receive data corresponding to a thermal level of the wireless communication device;
receive one or more packets for transmission to a wireless communication node; and
apply the thermal level to one or more criterion, to selectively transmit, or forego transmission of, the one or more packets to the wireless communication node.
